(19) United States
(12) Patent Application Publication
(10) Pub. No.: US 2011/0095051 A1
(43) Pub. Date: Apr. 28, 2011

(54) STRUCTURE OF AUTOMATIC FOAM SOAP DISPENSER

(76) Inventors: Wei-Ta LIAO, Taipei County (TW); Huang Tsai, Taipei County (TW); Kuo-Chou Lee, Keelung City (TW); Tsan-Chang Huang, Taipei City (TW)

(21) Appl. No.: 12/607,676

(22) Filed: Oct. 28, 2009

(51) Int. Cl. B67D 7/08; B67D 7/06; B67D 7/22; B67D 7/56

(52) U.S. Cl. 222/52; 222/23; 222/63; 222/156; 222/333

(57) ABSTRACT

The present invention provides an automatic foam soap dispenser used for single soap reservoir which is pressed from top to down. The automatic foam soap dispenser includes a covering housing opened downwardly for accommodating a pressing-typed soap reservoir, a control circuit board, a motor, and a sensor. The soap reservoir has a pressing head at the top thereof, the pressing head is communicated with a connecting head, and the connecting head has an extension pipe to communicate with a foam nozzle, which is mounted at the bottom of the covering housing. Moreover, an extension fixing board is extended inside the covering housing for mounting a transmission gear set, which is driven by the motor to turn, and a swinging pressing board, wherein the transmission gear set has a cam, and a first end of the swinging pressing board is pivotally connected to the cam and the transmission gear set, and a second end of the swinging pressing board is leaned on the pressing head or the connecting head. Accordingly, the present invention not only complies with the usual practice of downward soap output, but also prolongs the lifetime of the soap reservoir and the soap dispenser, and the problem of soap dropping caused from the remaining foam soap is also solved.

### FIELD OF THE INVENTION

The present invention is related to the structure of an automatic soap dispenser, and more particularly, to an automatic foam soap dispenser used for a soap bottle pressed downwardly (such as, the pressing bottles for hand soap and shampoo found in the market).

### BACKGROUND OF THE INVENTION

Owing to the development of technology and the improvement of life quality, the manual soap dispenser has been replaced by the automatic soap dispenser with the sensing technology.

The current automatic soap dispenser, as disclosed in a R.O.C patent No. M328853, entitled “Soap dispensing mechanism for automatic soap dispenser”, includes a driving device, composed of a motor and a gear set, for driving a tube pressing lever to press a soap tube linked to a soap reservoir so as to output the soap. The tube pressing lever, which is pivotally connected to a protruded axle of a substrate in the driving device, has a curved side and an opposite flat side, and the curved side is rejected against a trigger, which is pivotally connected to an output axle of the gear set of the driving device. Moreover, a blocking board is mounted at a rear side of a front cover of a housing of the soap dispenser, and the soap tube linked to the soap reservoir is located between the tube pressing lever and the blocking board. Accordingly, through the motor drives the gear set, the trigger turns to reject against the tube pressing lever so as to force the lever to swing toward the soap tube, and by cooperating with the block board, the soap tube can be pressed.

Although the manual operation is replaced by the sensing technology in the automatic soap dispenser described above, there still have some disadvantages as followed:

1. In the conventional automatic foam soap dispenser, the soap reservoir is designed to be upside down, so that when the soap reservoir is pressed, the valve body compresses air into the soap reservoir. When the net is mounted inside the outlet, the air will push the soap toward the outlet and then pass through the net for making foam. However, since the valve body is close to the net and the net is close to the outlet, the foam is easily gathered around the outlet and then be sucked back during the next operation of the valve body, so that the lubricant movement of the valve body might be influenced by the foam, thereby reducing the lifetime of the valve body.

2. Since the foam is frequently remained and gathered around the outlet of the automatic soap dispenser, when the liquid soap is separated from the air (namely, the bubble is broken) after a period of time, the liquid soap will drop to the floor or the tape platform to cause contamination.

### SUMMARY OF THE INVENTION

The object of the present invention is to provide an automatic foam soap dispenser which not only complies with the usual practice of downward soap output, but also prolongs the lifetime.

For achieving the object described above, the present invention provides an automatic foam soap dispenser, including a covering housing opened downwardly for accommodating a pressing-typed soap reservoir and a foam nozzle opened downwardly at the bottom thereof, wherein the soap reservoir has a pressing head at the top thereof, the pressing head is communicated with a connecting head, and the connecting head extends an extension pipe to communicate with the foam nozzle; a control circuit board electrically connected to a power source; a motor controlled by the control circuit board, wherein a transmission gear set, which is driven by the motor to turn, and a swinging pressing board are mounted on an extension fixing board extended from the covering housing inside, and wherein the transmission gear set has a cam, and a first end of the swinging pressing board is pivotally connected to the cam and the transmission gear set, and a second end of the swinging pressing board is leaned on the pressing head or the connecting head; and a sensor for sensing an approach of an external object and feedbacking a signal to the control circuit board so as to trigger the motor to turn and then drive the swinging pressing board to press the soap reservoir.

Another object of the present invention is to solve the problem of soap dropping caused from the remaining foam soap so as to keep the soap outlet clean.

For achieving this object, the present invention provides an automatic foam soap dispenser, including a covering housing opened downwardly for accommodating a pressing-typed soap reservoir and a foam nozzle opened downwardly at the inner bottom thereof, wherein the soap reservoir has a pressing head at the top thereof, the pressing head is communicated with a connecting head, and the connecting head extends an extension pipe to communicate with the foam nozzle; a control circuit board electrically connected to a power source; a motor controlled by the control circuit board, wherein a transmission gear set, which is driven by the motor to turn, and a swinging pressing board are mounted on an extension fixing board extended from the covering housing inside, and wherein the transmission gear set has a cam, and a first end of the swinging pressing board is pivotally connected to the cam, and a second end of the swinging pressing board is leaned on the pressing head or the connecting head; and a sensor for sensing an approach of an external object and feedbacking a signal to the control circuit board so as to trigger the motor to turn and then drive the swinging pressing board to press the soap reservoir, wherein the foam nozzle has a foam net inside, the foam nozzle further has a foam outlet, at the bottom thereof, communicated with the extension pipe, and an outlet extension portion with an adhesion plane surrounding thereof is further formed around the foam outlet.

Accordingly, as compared with the prior arts, the present invention is advantageous of:

1. According to the present invention, the soap reservoir can be in an upright position with the pressing head at top, and by the extension pipe, the foam nozzle can be mounted at the inner bottom of the covering housing, in the result that the foam outlet is distant from a valve body of the soap reservoir, so that the foam will not be gathered around the foam outlet, thereby preventing the foam suction, which may influence the movement of the valve body, and thus prolonging the lifetime of the soap reservoir.

2. Through the outlet extension portion mounted around the foam outlet at the bottom of the foam nozzle and the adhesion plate surrounding the outlet extension portion, the foam remained and gathered around the foam outlet, owing to the surface tension, can diffuse and adhere to the adhesion plane so as to avoid the soap from dropping, thereby keep clean.

3. The swinging pressing board is designed in accordance with the lever principle, in which the first end of the swinging pressing board is cooperated with the cam, and owing to the height difference of the cam, the second end can be moved up and down to press the pressing head. Besides, since the swinging pressing board moves in accordance with the lever principle, which turns upon a fixed axle, the wearing caused by torsion can be minimized, thereby improving the durability of the transmission gear set.

### BRIEF DESCRIPTION OF THE DRAWINGS

The foregoing aspects and many of the attendant advantages of the present invention will be more readily appreciated as the same becomes better understood by reference to the following detailed description, when taken in conjunction with the accompanying drawings, wherein:

FIG. 1 is a schematic view showing the three-dimensional appearance of an automatic foam soap dispenser according to the present invention;

FIG. 2 is a schematic view showing a portion of FIG. 1 according to the present invention;

FIG. 3 is a decomposition drawing of FIG. 2 according to the present invention;

FIG. 4A˜FIG. 4B are sectional views of FIG. 1 for showing the operation actions thereof according to the present invention; and

FIG. 4C is a partial magnification view of FIG. 4A according to the present invention.

### DESCRIPTION OF THE PREFERRED EMBODIMENT

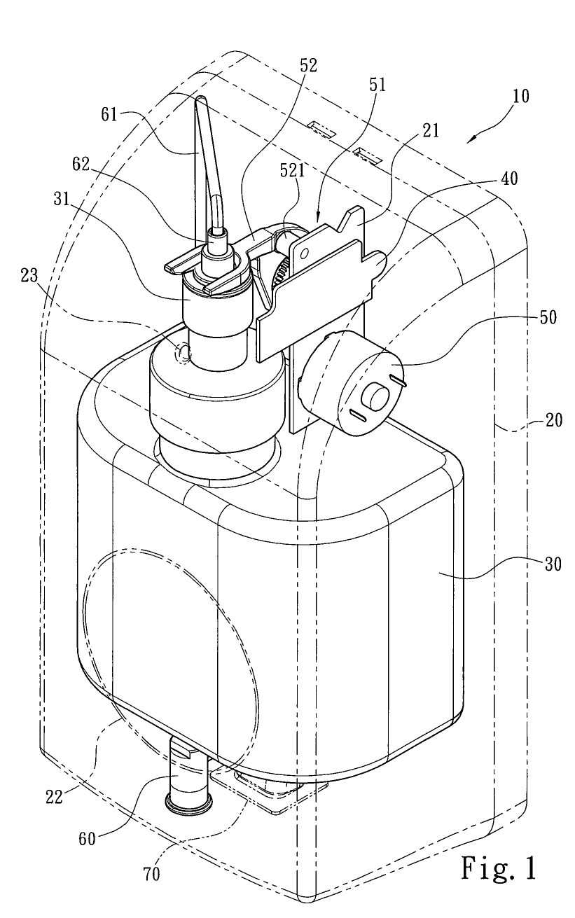

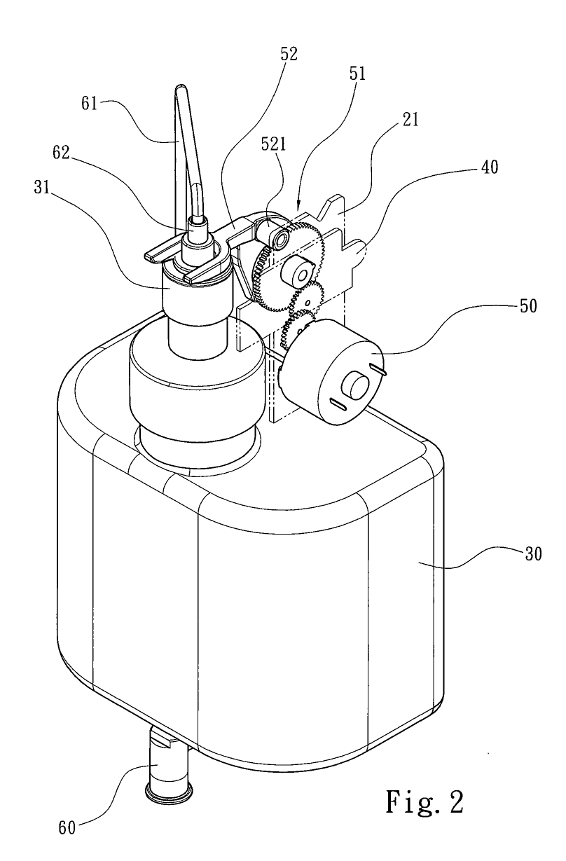

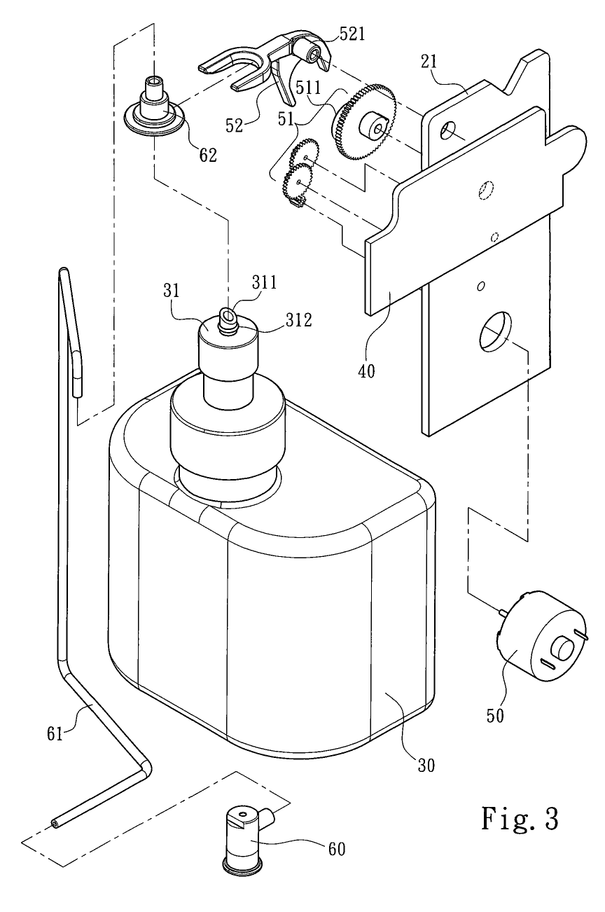

Please refer to FIGS. 1 to 3 for showing the three-dimensional appearance and the decomposition details of the automatic soap dispenser according to the present invention. As shown, the automatic foam soap dispenser 10 of the present invention includes a covering housing 20 opened downwardly and a transparent window 22 for exposing a pressing-typed soap reservoir 30, and a power indication light 23 for showing the power condition of a control circuit board 40. The covering housing 20 accommodates the pressing-typed soap reservoir 30, the control circuit board 40 electrically connected to a power source, a motor 50 controlled by the control circuit board 40, and a sensor 70 for sensing the approach of an external object and feedbacking a signal to the control circuit board 40 so as to trigger the motor 50 to turn and press the pressing-typed soap reservoir 30. Here, the soap reservoir 30, at the top thereof, has a pressing head 31, which can be pressed downwardly, and the pressing head 31 is communicated with a connecting head 62, such that when the pressing-typed soap reservoir 30 is in an upright position, the soap can be outputted by downwardly pressing the pressing head 31. Moreover, the pressing head 31 has a connecting nozzle 311 which is tightly connected to the connecting head 62, and between the connecting nozzle 311 and the connecting head 62, a leakproof ring 312, such as, a rubber ring, is further mounted. Through mounting the leakproof ring 312, when the soap in the pressing-typed soap reservoir 30 is used up, the connecting head 62 and the pressing head 31 can be separated more rapidly for replace the pressing-typed soap reservoir 30. Furthermore, a foam nozzle 60 is further mounted at the bottom of the covering housing 20 and is communicated with an extension pipe 61 extended from the connecting head 62. Besides, an extension fixing board 21 is extended inside the covering housing 20 for mounting a transmission gear set 51, which is driven by the motor 50 to turn, and a swinging pressing board 52, wherein the transmission gear set 51 has a cam 511, and a first end of the swinging pressing board 52 is pivotally connected to the cam 511, and a second end of the swinging pressing board 52 is leaned on the pressing head 31 or the connecting head 62.

It should be noticed that, in the present invention, through the extension pipe 61, the foam nozzle 60 can be positioned at the bottom of the covering housing 20 and thus distant from a valve body (not shown since the valve body is disposed inside the pressing-typed soap reservoir 30 and is well known in the art) of the pressing-typed soap reservoir 30, so that the foam will not be remained and gathered around a foam outlet 600, thereby preventing the foam suction, which influences the movement of the valve body, and thus prolonging the lifetime of the pressing-typed soap reservoir 30.

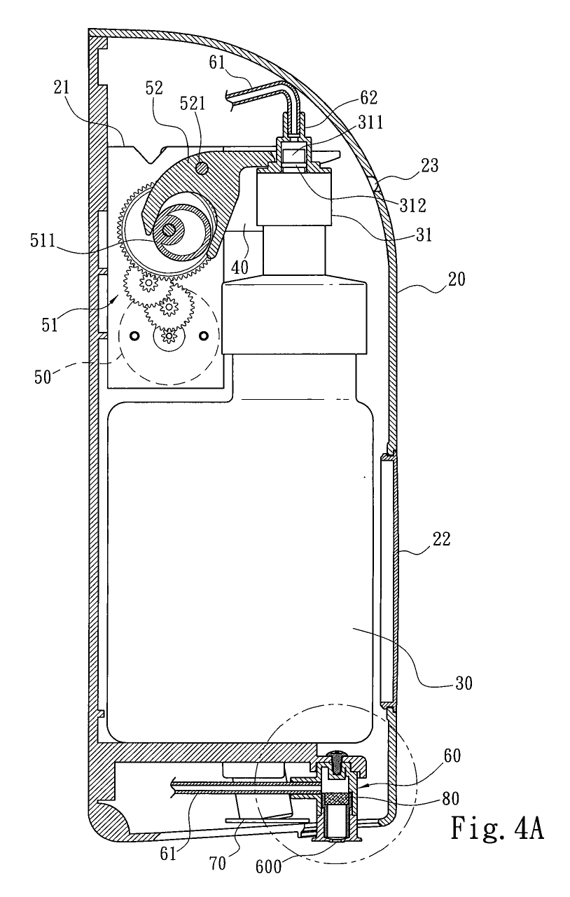

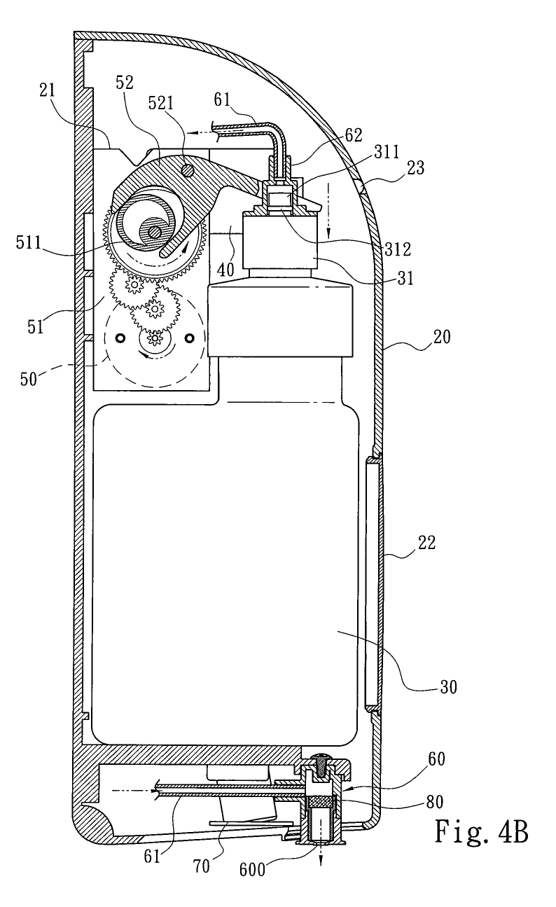

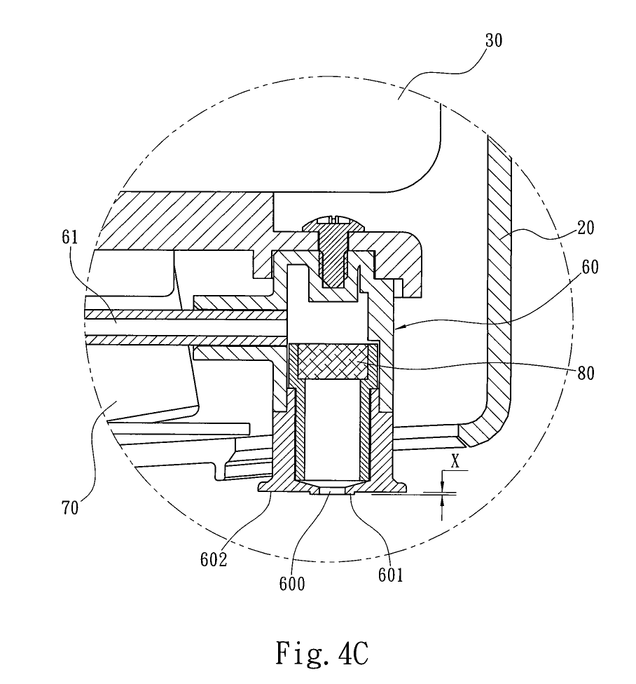

Please further refer to FIG. 4A and FIG. 4B which are sectional views of FIG. 1 for showing the operation actions thereof. As shown, when the sensor 70 of the automatic foam soap dispenser 10 senses the external object, the signal is feedbacked to the control circuit board 40 to trigger the motor 50 to drive the transmission gear set 51. Then, owing to the height difference of the cam 511 on the transmission gear set 51, the swinging pressing board 52 will downwardly press the pressing head 31 (as shown in FIG. 4B). When the swinging pressing board 52 downwardly presses the pressing head 31 to the lowest position, the control circuit board 40 electrically disconnects with the motor 50, and then, owing to the inertia of rotation, the motor 50 can turn back, thereby completing one pressing motion. A next pressing motion will be started until the sensor 70 senses another approach of the external object. Here, after the pressing head 31 is pressed, the soap reservoir 30 delivers the liquid soap via the extension pipe 61 to the foam nozzle 60 by gas pressure, and a foam net 80 is mounted inside the foam nozzle 60 can make the liquid soap to form uniform foams so as to further be delivered to the foam outlet 600. Because the swinging pressing board 52 is connected to the extension fixing board 21 through an axial shaft 521 in a lever design and also cooperated with the cam 511 through the first end thereof, the height difference of the cam 511 can drive the second end of the swinging pressing board 52 to move up or down, so as to achieve the upward and downward movements of the pressing head 31. Here, since the swinging pressing board 52 is moved in accordance with the lever principle, which rotates upon a fixed axle, the wearing caused by torsion can be minimized, thereby improving the durability of the transmission gear set 51.

Please further refer to FIG. 4C, which is a partial magnification of FIG. 4A. As shown, the foam nozzle 60 opened downwardly is mounted at the bottom of the covering housing 20, and the connecting head 62 extends the extension pipe 61 to communicate with the foam nozzle 60. The foam nozzle 60 has a net for making foam 80 mounted inside and has a foam outlet 600 formed at the bottom thereof and communicated with the extension pipe 61, and around the foam outlet 600, an outlet extension portion 601 is further formed with an adhesion plane 602 surrounding thereof. Here, the bottom of the outlet extension portion 601 is protruded a height X from the adhesion plane 602, and preferably, the height X is larger than 0.01 mm and less than 0.8 mm or equal to 0.8 mm.

It should be noticed that through the outlet extension portion 601 mounted around the foam outlet 600 at the bottom of the foam nozzle 60 and the adhesion plate 602 surrounding the outlet extension portion 601, owing to the surface tension, the foam remained around the foam outlet 600 will diffuse to the adhesion plane 602, so as to avoid the soap from dropping, thereby keeping the outlet and the environment clean.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An automatic foam soap dispenser, comprising:
a covering housing opened downwardly for accommodating a pressing-typed soap reservoir therein and a foam nozzle opened downwardly at the bottom thereof, wherein the soap reservoir at the top thereof has a pressing head which is pressed downwardly for outputting a liquid soap, the pressing head is communicated with a connecting head at the top thereof, and the connecting head extends an extension pipe to communicate with the foam nozzle;
a control circuit board electrically connected to a power source;
a motor controlled by the control circuit board, wherein a transmission gear set, which is driven by the motor to turn, and a swinging pressing board are mounted on an extension fixing board extended from the covering housing inside, and the transmission gear set has a cam, and a first end of the swinging pressing board is pivotally connected to the cam and the transmission gear set, and a second end of the swinging pressing board is leaned on the pressing head or the connecting head; and
a sensor for sensing an approach of an external object and feedbacking a signal to the control circuit board so as to trigger the motor to turn and then drive the swinging pressing board to press the soap reservoir.

2. The automatic foam soap dispenser as claimed in claim 1, wherein the pressing head has a connecting nozzle which is tightly connected to the connecting head.

3. The automatic foam soap dispenser as claimed in claim 2, wherein the connecting nozzle and the connecting head has a leakproof ring mounted therebetween.

4. The automatic foam soap dispenser as claimed in claim 3, wherein the leakproof ring is a rubber ring.

5. The automatic foam soap dispenser as claimed in claim 3, wherein the foam nozzle has a foam net inside, and the sensor is mounted on the covering housing aside the foam nozzle.

6. The automatic foam soap dispenser as claimed in claim 5, wherein the foam nozzle, at the bottom thereof, has a foam outlet communicated with the extension pipe.

7. The automatic foam soap dispenser as claimed in claim 6, wherein an outlet extension portion is further formed around the foam outlet, and the outlet extension portion has an adhesion plane surrounding thereof.

8. The automatic foam soap dispenser as claimed in claim 7, wherein the bottom of the outlet extension portion is protruded a height from the adhesion plane.

9. The automatic foam soap dispenser as claimed in claim 8, wherein the height is larger than 0.01 mm and less than 0.8 mm or equal to 0.8 mm.

10. The automatic foam soap dispenser as claimed in claim 8, wherein a transparent window for exposing the soap reservoir and a power indication light for showing the power condition of the control circuit board are mounted on the covering housing.

11. The automatic foam soap dispenser as claimed in claim 1, wherein the foam nozzle has a foam net inside, and the sensor is mounted on the covering housing aside the foam nozzle.

12. The automatic foam soap dispenser as claimed in claim 11, wherein the foam nozzle, at the bottom thereof, has a foam outlet communicated with the extension pipe.

13. The automatic foam soap dispenser as claimed in claim 12, wherein an outlet extension portion is further formed around the foam outlet, and the outlet extension portion has an adhesion plane surrounding thereof.

14. The automatic foam soap dispenser as claimed in claim 13, wherein the bottom of the outlet extension portion is protruded a height from the adhesion plane.

15. The automatic foam soap dispenser as claimed in claim 14, wherein the height is larger than 0.01 mm and less than 0.8 mm or equal to 0.8 mm.

16. The automatic foam soap dispenser as claimed in claim 14, wherein a transparent window for exposing the soap reservoir and a power indication light for showing the power condition of the control circuit board are mounted on the covering housing.
